(19) United States
(12) Patent Application Publication
(10) Pub. No.: US 2008/0210090 A1
(43) Pub. Date: Sep. 4, 2008

(54) Extruded Porous Ceramic Fuel Cell Reformer Cleanup Substrate

(75) Inventor: Bilal Zuberi, Cambridge, MA (US)

Correspondence Address: GEO2 TECHNOLOGIES, 12-R CABOT ROAD, WOBURN, MA, 01801, US

(73) Assignee: GEO2 Technologies, Inc., Wobum, MA (US)

(21) Appl. No.: 11/846,947

(22) Filed: Aug. 29, 2007

Related U.S. Application Data
(60) Provisional application No. 60/824,088, filed on Aug. 31, 2006.

(51) Int. Cl. B01D 53/02; B32B 3/12

(52) U.S. Cl. 95/90; 428/116

(57) ABSTRACT

A fuel cell reformer cleanup substrate is an extruded porous substrate of fiber-based inorganic materials. More particularly, the present invention enables an efficient fuel cell reformate cleanup filtration using a highly porous, and permeable honeycomb substrate having a washcoat that adsorbs impurities in the reformate stream upstream of a fuel cell. The porous substrate can be fabricated using an extrusion process and a number of washcoat compositions can be disposed within the porous substrate to provide adsorption of the reformate impurities.

### CROSS REFERENCE TO RELATED APPLICATIONS

This application claims priority to U.S. provisional patent application No. 60/824,088, filed Aug. 31, 2006, and entitled “Extruded Porous Ceramic Fuel Cell Reformer Cleanup Substrate”, which is incorporated by reference herein in its entirety.

### BACKGROUND

1. Field of the Invention

The present invention relates generally to a ceramic substrate used as a fuel cell reformer cleanup substrate, and in one particular implementation to an extruded porous ceramic fuel cell reformer cleanup substrate.

2. Description of the Related Art

Fuel cells are electrochemical energy conversion systems and devices that produce electricity from fuel. Generally, a fuel cell extracts the energy released from the chemical reaction in the formation of water from hydrogen and oxygen. In a fuel cell, the reaction occurs in the presence of a catalyst without combustion in a highly efficient manner, with water vapor as the predominate byproduct of the reaction. Accordingly, fuel cells are considered to be efficient and clean sources of energy.

Hydrogen as a fuel source for fuel cells requires high pressure compression of the fuel in a gaseous form, or in a super-cooled liquid form. In either case, the fuel is extremely expensive to generate, store, and to handle safely. Hydrogen in a pure form is highly combustible, and requires specialized equipment and handling procedures.

An alternative way to provide hydrogen as a fuel for a fuel cell is through the use of a fuel cell reformer. A reformer is a device that removes hydrogen from hydrocarbon fuels, such as methane or gasoline. The output of a fuel cell reformer is ideally hydrogen gas, though due to the complexities in the chemical reaction within the reformer, and due to the impurities that naturally occur within hydrocarbon-based fuels, impurities are often emitted from the reformate stream. These impurities, if left within the reformate stream, can destroy the efficiency of the fuel cell, or even totally destroy the fuel cell itself.

Fuel cell reformer cleanup can be performed through the use of a honeycomb ceramic substrate having a catalyst applied to attract and adsorb the impurities passing through the substrate. A honeycomb substrate provides high surface area as a support for the catalyst, so that the catalyst is accessible to the reformate stream. However, to ensure that the substrate can collect all of the impurities so that the fuel cell efficiency is not destroyed, the substrate must be large enough to ensure sufficient residence time of the reformate stream within the substrate to capture all of the impurities.

Accordingly, the industry has a need for a fuel cell reformer cleanup substrate that has high porosity and an associated high permeability, so that the reformate stream has can be effectively cleaned in a compact unit without high backpressure. Preferably, the substrate would be cost-effective to manufacture, and could be manufactured with flexible physical, chemical, and reaction properties.

### SUMMARY

Briefly, the present invention provides a fuel cell reformer cleanup substrate that is a highly porous substrate formed in an extrusion process. More particularly, the present invention enables fibers, such as organic, inorganic, glass, ceramic or metal fibers, to be mixed into a mass that when extruded and cured, forms a highly porous substrate. Depending on the particular mixture, the present invention enables substrate porosities of about 60% to about 85%, and enables process advantages at other porosities, as well. The extrudable mixture may use a wide variety of fibers and additives, and is adaptable to a wide variety of operating environments and applications. Fibers are mixed with binders, pore-formers, extrusion aids, and fluid to form a homogeneous extrudable mass. The homogeneous mass is extruded into a green substrate. The more volatile material is preferentially removed from the green substrate, which allows the fibers to interconnect and contact. As the curing process continues, fiber-to-fiber bonds are formed to produce a structure having a substantially open pore network. The resulting porous substrate provides structural support for a washcoat in an adsorber type application, such as in the cleanup system for a fuel cell reformate stream.

In a more specific example, ceramic fibers are the mullite phase of aluminosilicate fibers.

In another specific example, a porous substrate may be used to clean up the reformate stream of a fuel cell reformer. The porous substrate in this example can be formed by extrusion of a mixture of ceramic-material fiber with additives. The porous substrate has a washcoat applied to at least a portion of the porous substrate adapted to reversibly adsorb components in the reformate stream, such as in the use of a revolver assembly. In this specific example, the porous substrate can be used in a stationary system or a mobile vehicle.

In other examples, the washcoat has an affinity for the adsorption of hydrogen sulfide, which is typically a component of a fuel cell reformate stream that can destroy a fuel cell if not removed from the reformate stream. Embodiments of this example includes washcoats comprising zinc oxide, lanthanum oxide, and rare-earth oxides. The penetration of the washcoat into the porous substrate provides significant advantages in the efficiency and performance of the porous substrate as a fuel cell reformate cleanup filter.

Advantageously, the disclosed fiber extrusion system produces a substrate having high porosity, and having an open pore network that enables an associated high permeability, as well as having sufficient strength according to application needs. The fiber extrusion system also produces a substrate with sufficient cost effectiveness to enable widespread use of the resulting filters and catalytic converters. The extrusion system is easily scalable to mass production, and allows for flexible chemistries and constructions to support multitudes of applications. The present invention represents a pioneering use of fiber material in an extrudable mixture. This fibrous extrudable mixture enables extrusion of substrates with very high porosities, at a scalable production, and in a cost-effective manner. By enabling fibers to be used in the repeatable and robust extrusion process, the present invention enables mass production of filters and catalytic substrates for wide use throughout the world.

These and other features of the present invention will become apparent from a reading of the following description, and may be realized by means of the instrumentalities and combinations particularly pointed out in the appended claims.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a block diagram of a system for extruding a porous substrate in accordance with the present invention.

FIG. 2 is an illustration of a fibrous extrudable mixture in accordance with the present invention.

FIGS. 3A and 3B are illustrations of an open pore network in accordance with the present invention.

FIG. 4 is an electron microscope picture of an open pore network in accordance with the present invention and a close pore network of the prior art.

FIG. 5 is an illustration of a filter block using a porous substrate in accordance with the present invention.

FIG. 6 are tables of fibers, binders, pore formers, fluids, and rheologies useful with the present invention.

FIG. 7 is a block diagram of a system for extruding a porous substrate in accordance with the present invention.

FIG. 8 is a block diagram of a system for curing a porous substrate in accordance with the present invention.

FIG. 9 is a block diagram of a system for processing fibers for a porous substrate in accordance with the present invention.

FIG. 10 is a diagram of a reformate stream filter in accordance with the present invention.

FIG. 11 is a diagram of a flow-through reformate stream filter in accordance with the present invention.

FIG. 12 is diagram of a wall-flow reformate stream filter in accordance with the present invention.

FIG. 13 is a diagram of a revolver based system according to the present invention.

FIG. 14 is a diagram of a motor vehicle powered by a fuel cell using a reformate stream filter of the present invention.

FIG. 15 is a diagram showing the alumina-silica phase relationship.

### DETAILED DESCRIPTION

Detailed descriptions of examples of the invention are provided herein. It is to be understood, however, that the present invention may be exemplified in various forms. Therefore, the specific details disclosed herein are not to be interpreted as limiting, but rather as a representative basis for teaching one skilled in the art how to employ the present invention in virtually any detailed system, structure, or manner.

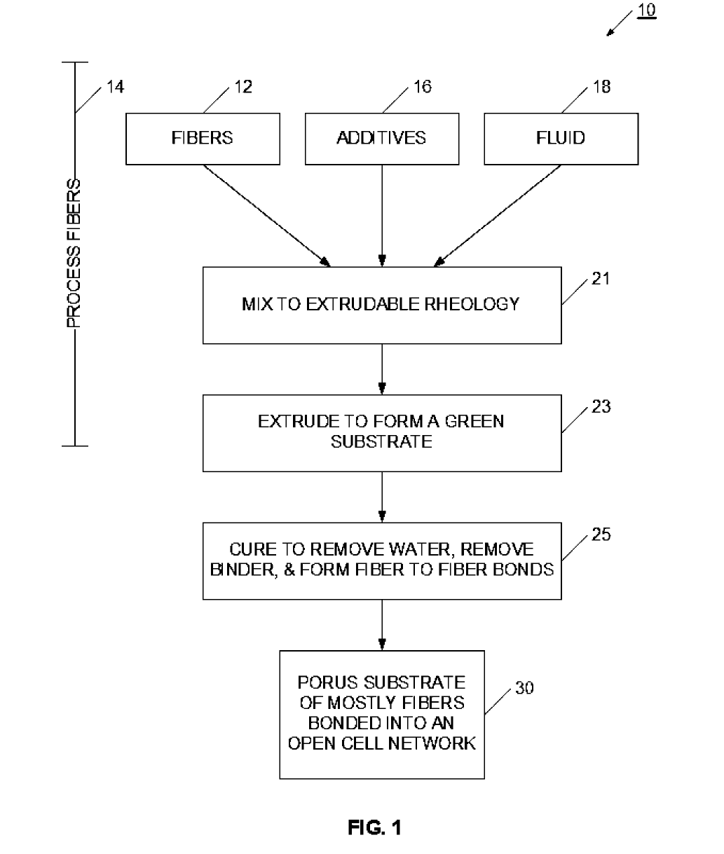

Referring now to FIG. 1, a system for extruding a porous substrate is illustrated. Generally, system 10 uses an extrusion process to extrude a green substrate that can be cured into the final highly porous substrate product. System 10 advantageously produces a substrate having high porosity, having a substantially open pore network enabling an associated high permeability, as well as having sufficient strength according to application needs. The system 10 also produces a substrate with sufficient cost effectiveness to enable widespread use of the resulting filters and catalytic converters. The system 10 is easily scalable to mass production, and allows for flexible chemistries and constructions to support multitudes of applications.

System 10 enables a highly flexible extrusion process, so is able to accommodate a wide range of specific applications. In using system 10, the substrate designer first establishes the requirements for the substrate. These requirements may include, for example, size, fluid permeability, desired porosity, pore size, mechanical strength and shock characteristics, thermal stability, and chemical reactivity limitations. According to these and other requirements, the designer selects materials to use in forming an extrudable mixture. Importantly, system 10 enables the use of fibers 12 in the formation of an extruded substrate. These fibers may be, for example, ceramic fibers, organic fibers, inorganic fibers, polymeric fibers, oxide fibers, vitreous fibers, glass fibers, amorphous fibers, crystalline fibers, monocrystalline fibers, polycrystalline fibers, non-oxide fibers, carbide fibers, metal fibers, other inorganic fiber structures, or a combination of these. However, for ease of explanation, the use of ceramic fibers will be described, although it will be appreciated that other fibers may be used. Also, the substrate will often be described as a filtering substrate or a catalytic substrate, although other uses are contemplated and within the scope of this teaching. The designer selects the particular type of fiber based upon application specific needs. For example, the ceramic fiber may be selected as a mullite fiber, an aluminum silicate fiber, or other commonly available ceramic fiber material. The fibers typically need to be processed 14 to cut the fibers to a usable length, which may include a chopping process prior to mixing the fibers with additives. Also, the various mixing and forming steps in the extrusion process will further cut the fibers.

According to specific requirements, additives 16 are added. These additives 16 may include binders, dispersants, pore formers, plasticizers, processing aids, and strengthening materials. Also, fluid 18, which is typically water, is combined with the additives 16 and the fibers 12. The fibers, additives, and fluid are mixed to an extrudable rheology 21. This mixing may include dry mixing, wet mixing, and shear mixing. The fibers, additives, and fluid are mixed until a homogeneous mass is produced, which evenly distributes and arranges fibers within the mass. The fibrous and homogenous mass is then extruded to form a green substrate 23. The green substrate has sufficient strength to hold together through the remaining processes.

The green substrate is then cured 25. As used in this description, “curing” is defined to include at least two important process steps: 1) binder removal and 2) bond formation. The binder removal process removes free water, removes most of the additives, and enables fiber-to-fiber contact. Often the binder is removed using a heating process that burns off the binder, but it will be understood that other removal processes may be used dependent on the specific binder used. For example, some binder may be removed using an evaporation or sublimation process. Some binders and or other organic components may melt before degrading into a vapor phase. As the curing process continues, fiber-to-fiber bonds are formed. These bonds facilitate overall structural rigidity, as well as create the desirable porosity and permeability for the substrate. Accordingly, the cured substrate 30 is a highly porous substrate of mostly fibers bonded into an open pore network 30. The substrate may then be used as a substrate for many applications, including as a substrate for filtering applications, adsorber applications, and catalytic conversion applications. Advantageously, system 10 has enabled a desirable extrusion process to produce substrates having porosities of up to about 90%.

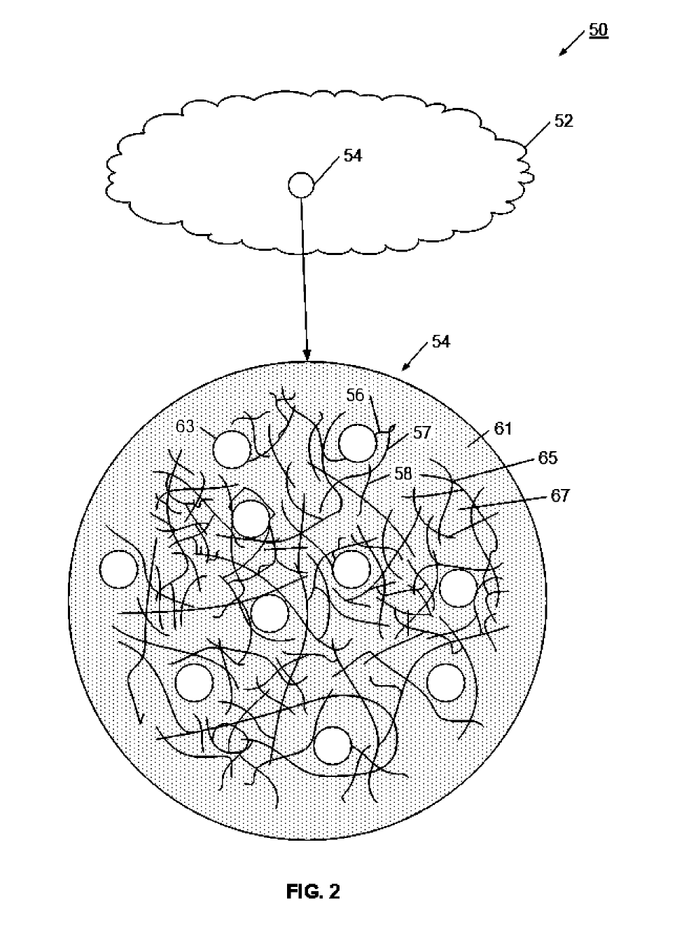

Referring now to FIG. 2, an extrudable material 50 is illustrated. The extrudable material 50 is ready for extrusion from an extruder, such as a piston or screw extruder. The extrudable mixture 52 is a homogeneous mass including fibers, plasticizers, and other additives as required by the specific application. FIG. 2 illustrates an enlarged portion 54 of the homogeneous mass. It will be appreciated that the enlarged portion 54 may not be drawn to scale, but is provided as an aid to this description. The extrudable mixture 52 contains fibers, such as fibers 56, 57, and 58. These fibers have been selected to produce a highly porous and rigid final substrate with desired thermal, chemical, mechanical, and filtration characteristics. As will be appreciated, substantially fibrous bodies have not been considered to be extrudable, since they have no plasticity of their own. However, it has been found that through proper selection of plasticizers and process control, an extrudable mixture 52 comprising fibers may be extruded. In this way, the cost, scale, and flexibility advantages of extrusion may be extended to include the benefits available from using fibrous material.

Generally, a fiber is considered to be a material with a relatively small diameter having an aspect ratio greater than one. The aspect ratio is the ratio of the length of the fiber divided by the diameter of the fiber. As used herein, the ‘diameter’ of the fiber assumes for simplicity that the sectional shape of the fiber is a circle; this simplifying assumption is applied to fibers regardless of their true sectional shape. For example, a fiber with an aspect ratio of 10 has a length that is 10 times the diameter of the fiber. The diameter of the fiber may be 6 micron, although diameters in the range of about 1 micron to about 25 microns are readily available. It will be understood that fibers of many different diameters and aspect ratios may be successfully used in system 10. As will be described in more detail with reference to later figures, several alternatives exist for selecting aspect ratios for the fibers. It will also be appreciated that the shape of fibers is in sharp contrast to the typical ceramic powder, where the aspect ratio of each ceramic particle is approximately 1.

The fibers for the extrudable mixture 52 may be metallic (some times also referred to as thin-diameter metallic wires), although FIG. 2 will be discussed with reference to ceramic fibers. The ceramic fibers may be in an amorphous state, a vitreous state, a crystalline state, a poly-crystalline state, a mono-crystalline state, or in a glass-ceramic state. In making the extrudable mixture 52, a relatively low volume of ceramic fiber is used to create the porous substrate. For example, the extrudable mixture 52 may have only about 10% to 40% ceramic fiber material by volume. In this way, after curing, the resulting porous substrate will have a porosity of about 90% to about 60%. It will be appreciated that other amounts of ceramic fiber material may be selected to produce other porosity values.

In order to produce an extrudable mixture, the fibers are typically combined with a plasticizer. In this way, the fibers are combined with other selected organic or inorganic additives. These additives provide three key properties for the extrudate. First, the additives allow the extrudable mixture to have a rheology proper for extruding. Second, the additives provide the extruded substrate, which is typically called a green substrate, sufficient strength to hold its form and position the fibers until these additives are removed during the curing process. And third, the additives are selected so that they burn off in the curing process in a way that facilitates arranging the fibers into an overlapping construction, and in a way that does not weaken the forming rigid structure. Typically, the additives will include a binder, such as binder 61. The binder 61 acts as a medium to hold the fibers into position and provide strength to the green substrate. The fibers and binder(s) may be used to produce a porous substrate having a relatively high porosity. However, to increase porosity even further, additional pore formers, such as pore former 63, may be added. Pore formers are added to increase open space in the final cured substrate. Pore formers may be spherical, elongated, fibrous, or irregular in shape. Pore formers are selected not only for their ability to create open space and based upon their thermal degradation behavior, but also for assisting in orienting the fibers. In this way, the pore formers assist in arranging fibers into an overlapping pattern to facilitate proper bonding between fibers during later stage of the curing. Additionally, pore-formers also play a role in the alignment of the fibers in preferred directions, which affects the thermal expansion of the extruded material and the strength along different axes.

As briefly described above, extrudable mixture 52 may use one or more fibers selected from many types of available fibers. Further, the selected fiber may be combined with one or more binders selected from a wide variety of binders. Also, one or more pore formers may be added selected from a wide variety of pore formers. The extrudable mixture may use water or other fluid as its plasticizing agent, and may have other additives added. This flexibility in formation chemistry enables the extrudable mixture 52 to be advantageously used in many different types of applications. For example, mixture combinations may be selected according to required environmental, temperature, chemical, physical, or other requirement needs. Further, since extrudable mixture 52 is prepared for extrusion, the final extruded product may be flexibly and economically formed. Although not illustrated in FIG. 2, extrudable mixture 52 is extruded through a screw or piston extruder to form a green substrate, which is then cured into the final porous substrate product.

The present invention represents a pioneering use of fiber material in a plastic batch or mixture for extrusion. This fibrous extrudable mixture enables extrusion of substrates with very high porosities, at a scalable production, and in a cost-effective manner. By enabling fibers to be used in the repeatable and robust extrusion process, the present invention enables mass production of filters and catalytic substrates for wide use throughout the world.

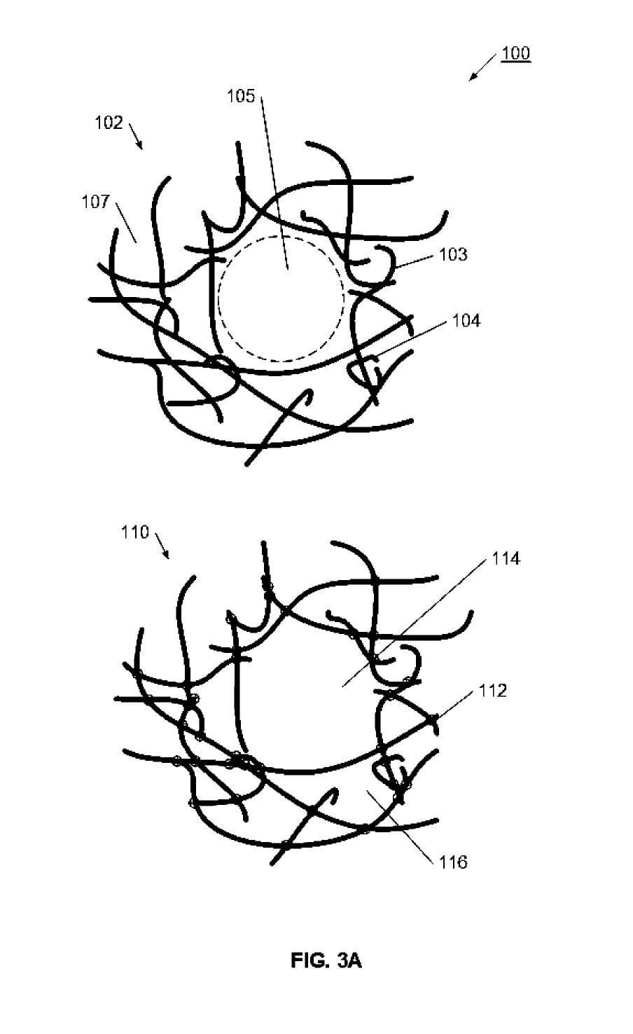

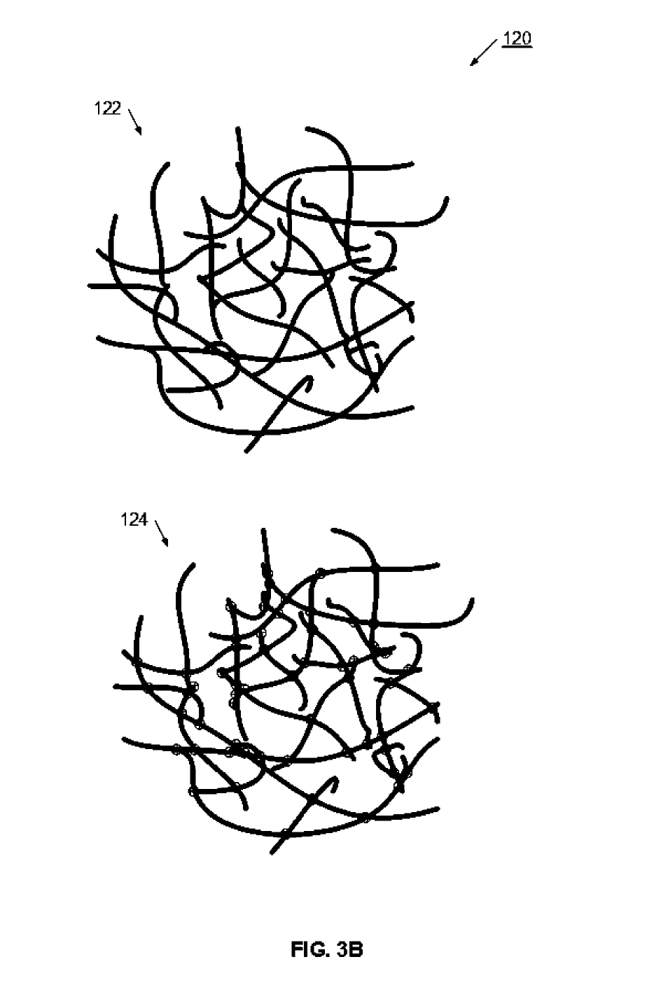

Referring to FIG. 3A, an enlarged cured area of a porous substrate is illustrated. The substrate portion 100 is illustrated after binder removal 102 and after the curing process 110. After binder removal 102, fibers, such as fiber 103 and 104 are initially held into position with binder material, and as the binder material burns off, the fibers are exposed to be in an overlapping, but loose, structure. Also, a pore former 105 may be positioned to produce additional open space, as well as to align or arrange fibers. Since the fibers only comprise a relatively small volume of the extrudable mixture, many open spaces 107 exist between the fibers. As the binder and pore former is burned off, the fibers may adjust slightly to further contact each other. The binder and pore formers are selected to burn off in a controlled manner so as not to disrupt the arrangement of the fibers or have the substrate collapse in burn off. Typically, the binder and pore formers are selected to degrade or burn off prior to forming bonds between the fibers. As the curing process continues, the overlapping and touching fibers begin to form bonds. It will be appreciated that the bonds may be formed in several ways. For example, the fibers may be heated to allow the formation of a liquid assisted sintered bond at the intersection or node of the fibers. This liquid state sintering may result from the particular fibers selected, or may result from additional additives added to the mixture or coated on the fibers. In other cases, it may be desirable to form a solid state sintered bond. In this case, the intersecting bonds form a grain structure connecting overlapping fibers. In the green state, the fibers have not yet formed physical bonds to one another, but may still exhibit some degree of green strength due to tangling of the fibers with one another. The particular type of bond selected will be dependent on selection of base materials, desired strength, and operating chemistries and environments. In some cases, the bonds are caused by the presence of inorganic binders presenting the mixture that hold the fibers together in a connected network. And do not burn off during the curing process.

Advantageously, the formation of bonds, such as bonds 112 facilitates forming a substantially rigid structure with the fibers. The bonds also enable the formation of an open pore network having very high porosity. For example, open-space 116 is created naturally by the space between fibers. Open space 114 is created as pore former 105 degrades or burns off. In this way, the fiber bond formation process creates an open pore network with no or virtually no terminated channels. This open pore network generates high permeability, high filtration efficiency, and allows high surface area for addition of catalyst, for example. It will be appreciated that the formation of bonds can depend upon the type of bond desired, such as solid-state or liquid-assisted/liquid-state sintering, and additives present during the curing process. For example, the additives, particular fiber selection, the time of heat, the level of heat, and the reaction environment may all be adjusted to create a particular type of bond.

Referring now to FIG. 3B, another enlarged cured area of a porous substrate is illustrated. The substrate portion 120 is illustrated after binder removal 122 and after the curing process 124. The substrate portion 120 is similar to the substrate portion 100 described with reference to FIG. 3A, so will not be described in detail. Substrate 120 has been formed without the use of specific pore formers, so the entire open pore network 124 has resulted from the positioning of the fibers with a binder material. In this way, moderately high porosity substrates may be formed without the use of any specific pore formers, thereby reducing the cost and complexity for manufacturing such moderate porosity substrates. It has been found that substrates having a porosity in the range of about 40% to about 60% may be produced in this way.

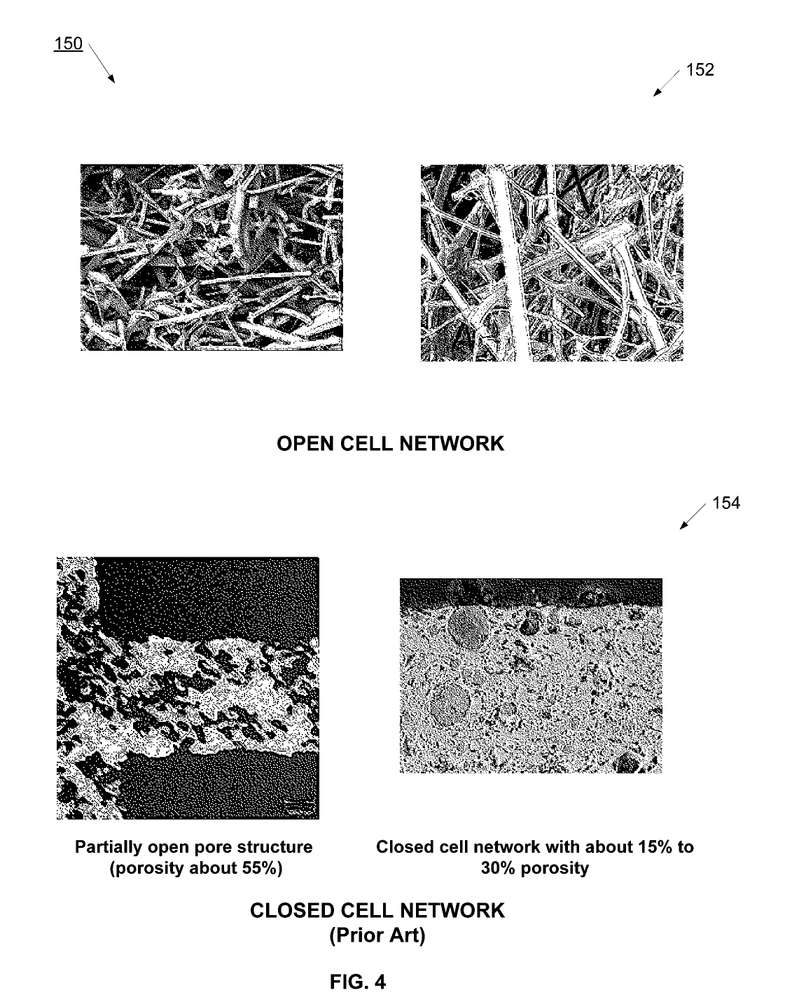

Referring now to FIG. 4, an electron microscope picture set 150 is illustrated. Picture set 150 first illustrates an open pore network 152 desirably created using a fibrous extrudable mixture. As can be seen, fibers have formed bonds at intersecting fiber nodes, and pore former and binders have been burned off, leaving a porous open pore network. In sharp contrast, picture 154 illustrates a typical closed cell network made using known processes. The partially closed pore network has a relatively high porosity, but at least some of the porosity is derived from closed channels. These closed channels do not contribute to permeability. In this way, an open pore network and a closed pore network having the same porosity, the open pore network will have a more desirable permeability characteristic.

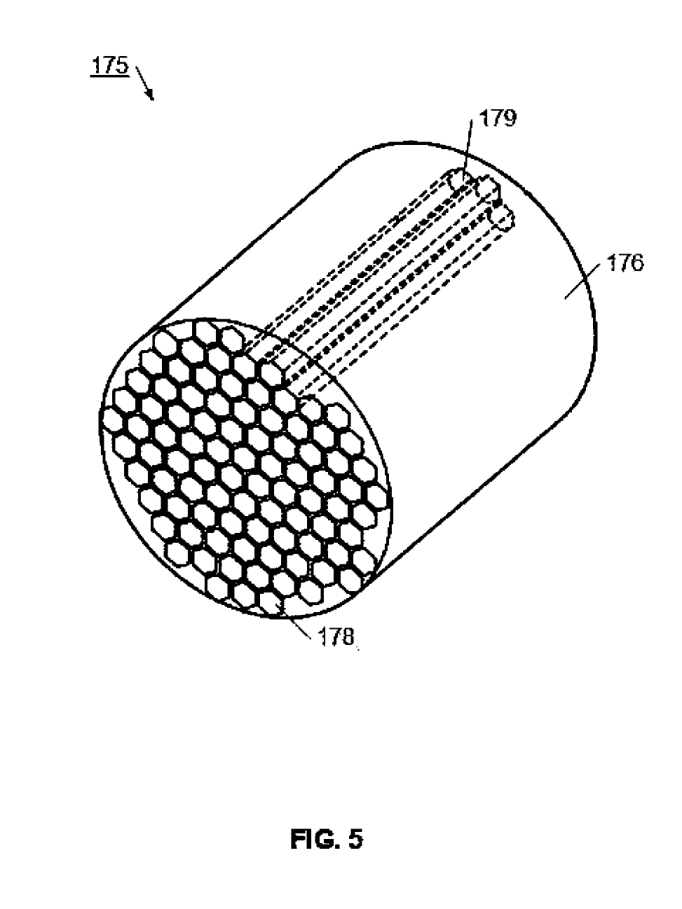

The extrudable mixture and process generally described thus far is used to produce a highly advantageous and porous substrate. In one example, the porous substrate may be extruded in to a filter block substrate 175 as illustrated in FIG. 5. Substrate block 175 has been extruded using a piston or screw extruder. The extruder could be conditioned to operate at room temperature, slightly elevated temperature or in a controlled temperature window. Additionally, several parts of the extruder could be heated to different temperatures to affect the slow characteristics, shear history, and gellation characteristics of the extrusion mix. Additionally, the size of the extrusion dies may also be sized accordingly to adjust the expected shrinkage in the substrate during the heating and sintering process. Advantageously, the extrudable mixture was a fibrous extrudable mixture having sufficient plasticizer and other additives to allow extrusion of fibrous material. The extruded green state block was cured to remove free water, burn off additives, and form structural bonds between fibers. The resulting block 175 has highly desirable porosity characteristics, as well as excellent permeability and high usable surface area. Also, depending on the particular fibers and additives selected, the block 175 may be constructed for advantageous depth filtering. The block 176 has channels 179 that extend longitudinally through the block. The inlets to the block 178 may be left open for a flow-through process, or every other opening may be plugged to produce a wall flow effect. Although block 175 is shown with hexagonal channels, it will be appreciated that other patterns and sizes may be used. For example, the channels may be formed with an evenly sized square, rectangular, or triangular channel pattern; a square/rectangular or octagon/square channel pattern having larger inlet channels; or in another symmetrical or asymmetrical channel pattern. The precise shapes and sizes of the channels or cells can be adjusted by adjusting the design of the die. For example, a square channel can be made to have curved corners by using EDM (Electronic Discharge Machining) to shape the pins in the die. Such rounded corners are expected to increase the strength of the final product, despite a slightly higher back-pressure. Additionally, die design can be modified to extrude honeycomb substrates where the walls have different thicknesses and the skin has a different thickness than the rest of the walls. Similarly, in some applications, an external skin may be applied to the extruded substrate for final definition of the size, shape, contour and strength.

When used as a flow-through device, the high porosity of block 176 enables a large surface area for the application of the washcoat or catalytic material. In this way, a highly effective and efficient catalytic converter may be made, with the converter having a low thermal mass. With such a low thermal mass, the resulting catalytic converter has good light off characteristics, and efficiently uses catalytic material. When used in a wall flow or wall filtering example, the high permeability of the substrate walls enable relatively low back pressures, while facilitating depth filtration. This depth filtration enables efficient particulate removal, as well as facilitates more effective regeneration. In some cases, however, mostly cake or surface filtration is observed. In wall-flow design, the fluid flowing through the substrate is forced to move through the walls of the substrate, hence enabling a more direct contact with the fibers making up the wall. Those fibers present a high surface area for potential reactions to take place, such as if a catalyst or adsorber washcoat is present. Since the extrudable mixture may be formed from a wide variety of fibers, additives, and fluids, the chemistry of the extrudable mixture may be adjusted to generate a block having specific characteristics. For example, if the final block is desired to be a diesel particulate filter, the fibers are selected to account for safe operation even at the extreme temperature of an uncontrolled regeneration. In another example, if the block is going to be used to filter a particular type of exhaust gas, the fiber and bonds are selected so as not to react with the exhaust gas across the expected operational temperature range. Although the advantages of the high porosity substrate have been described with reference to filters and catalytic converters, it will be appreciated that many other applications exist for the highly porous substrate.

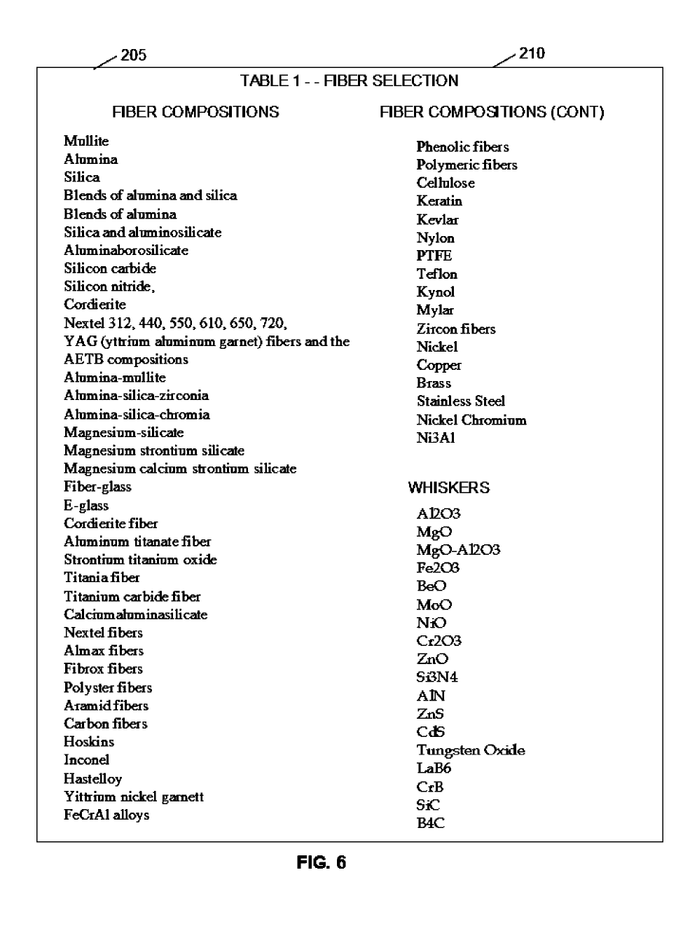

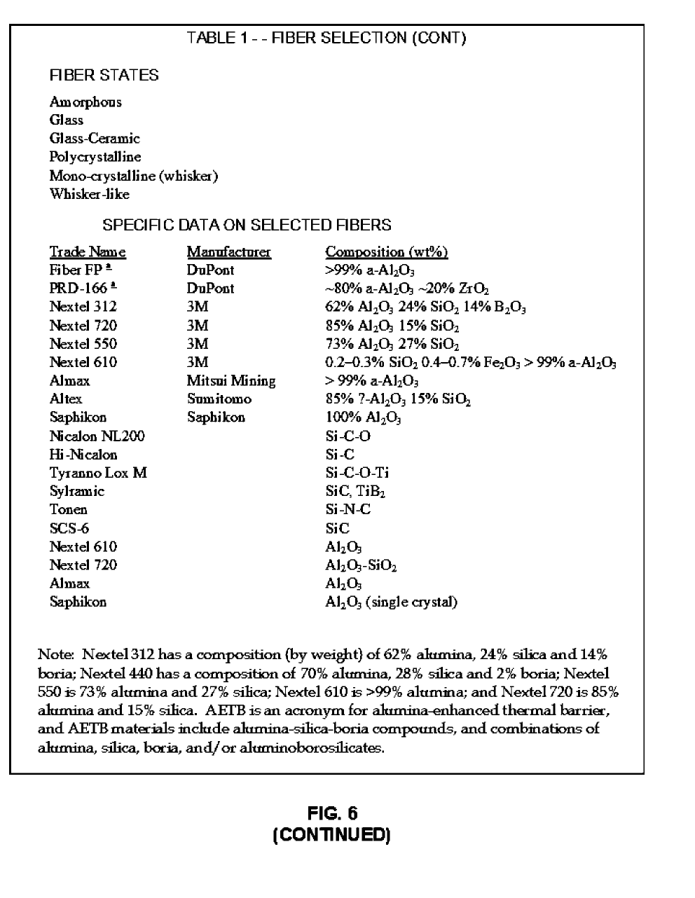

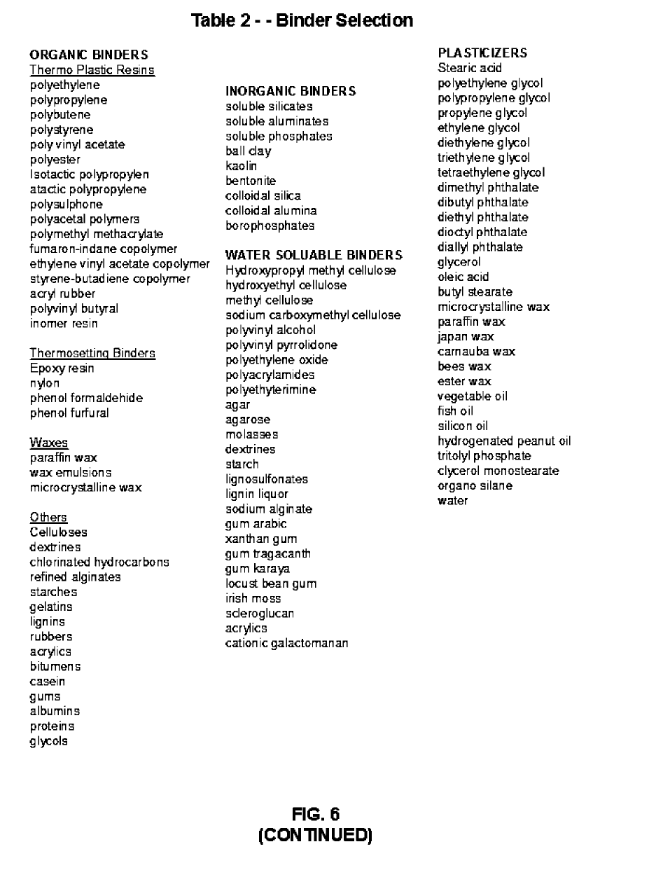

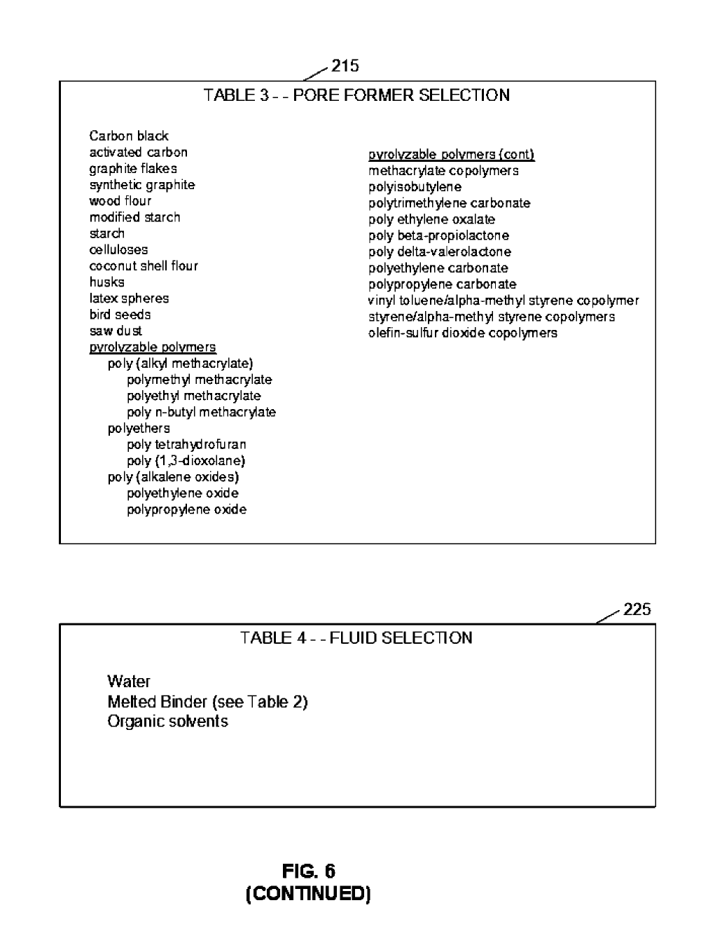

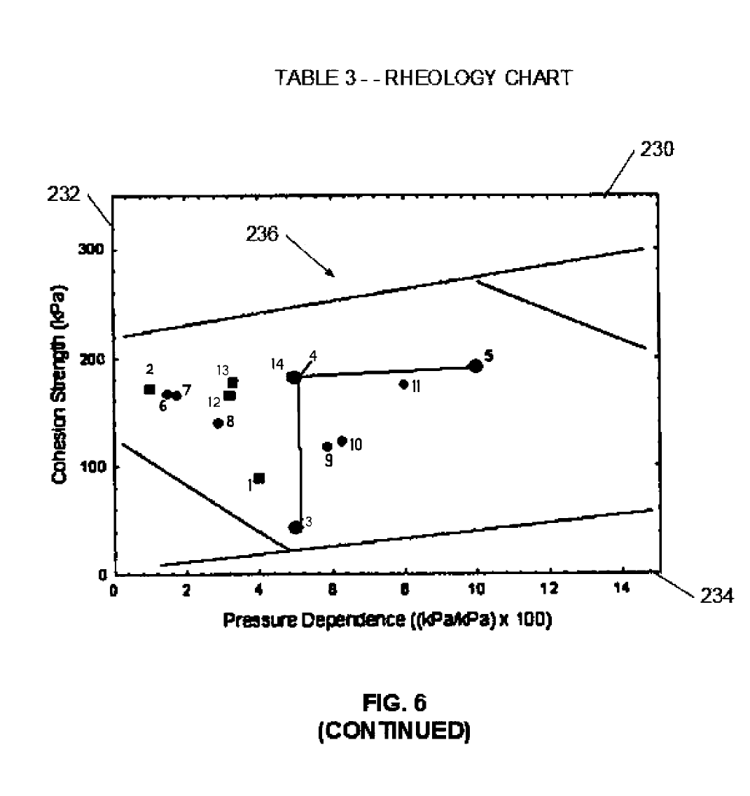

The fibrous extrudable mixture as described with reference to FIG. 2 may be formed from a wide variety of base materials. The selection of the proper materials is generally based on the chemical, mechanical, and environmental conditions that the final substrate must operate in. Accordingly, a first step in designing a porous substrate is to understand the final application for the substrate. Based on these requirements, particular fibers, binders, pore formers, fluids, and other materials may be selected. It will also be appreciated that the process applied to the selected materials may affect the final substrate product. Since the fiber is the primary structural material in the final substrate product, the selection of the fiber material is critical for enabling the final substrate to operate in its intended application. Accordingly, the fibers are selected according to the required bonding requirements, and a particular type of bonding process is selected. The bonding process may be a liquid state sintering, solid-state sintering, or a bonding requiring a bonding agent, such as glass-former, glass, clays, ceramics, ceramic precursors or colloidal sols. The bonding agent may be part of one of the fiber constructions, a coating on the fiber, or a component in one of the additives. It will also be appreciated that more than one type of fiber may be selected. It will also be appreciated that some fibers may be consumed during the curing and bonding process. In selecting the fiber composition, the final operating temperature is an important consideration, so that thermal stability of the fiber may be maintained. In another example, the fiber is selected so that it remains chemically inert and un-reactive in the presence of expected gases, liquids, or solid particulate matter. The fiber may also be selected according to its cost, and some fibers may present health concerns due to their small sizes, and therefore their use may be avoided. Depending upon the mechanical environment, the fibers are selected according to their ability to form a strong rigid structure, as well as maintain the required mechanical integrity. It will be appreciated that the selection of an appropriate fiber or set of fibers may involve performance and application trade-offs. FIG. 6, Table 1, shows several types of fibers that may be used to form a fibrous extrudable mixture. Generally, the fibers may be oxide or non-oxide ceramic, glass, organic, inorganic, or they may be metallic. For ceramic materials, the fibers may be in different states, such as amorphous, vitreous, poly-crystalline or mono-crystalline. Although Table 1 illustrates many available fibers, it will be appreciated that other types of fibers may be used.

Binders and pore formers may then be selected according to the type of fibers selected, as well as other desired characteristics. In one example, the binder is selected to facilitate a particular type of liquid state bonding between the selected fibers. More particularly, the binder has a component, which at a bonding temperature, reacts to facilitate the flow of a liquid bond to the nodes of intersecting fibers. Also, the binder is selected for its ability to plasticize the selected fiber, as well as to maintain its green state strength. In one example, the binder is also selected according to the type of extrusion being used, and the required temperature for the extrusion. For example, some binders form a gelatinous mass when heated too much, and therefore may only be used in lower temperature extrusion processes. In another example, the binder may be selected according to its impact on shear mixing characteristics. In this way, the binder may facilitate chopping fibers to the desired aspect ratio during the mixing process. The binder may also be selected according to its degradation or burnoff characteristics. The binder needs to be able to hold the fibers generally into place, and not disrupt the forming fiber structure during burnoff. For example, if the binder burns off too rapidly or violently, the escaping gases may disrupt the forming structure. Also, the binder may be selected according to the amount of residue the binder leaves behind after burnout. Some applications may be highly sensitive to such residue.

Pore formers may not be needed for the formation of relatively moderate porosities. For example, the natural arrangement and packing of the fibers within the binder may cooperate to enable a porosity of about 40% to about 60%. In this way, a moderate porosity substrate may be generated using an extrusion process without the use of pore formers. In some cases, the elimination of pore formers enables a more economical porous substrate to be manufactured as compared to known processes. However, when a porosity of more than about 60% is required, pore formers may be used to cause additional airspace within the substrate after curing. The pore formers also may be selected according to their degradation or burnoff characteristics, and also may be selected according to their size and shape. Pore size may be important, for example, for trapping particular types of particulate matter, or for enabling particularly high permeability. The shape of the pores may also be adjusted, for example, to assist in proper alignment of the fibers. For example, a relatively elongated pore shape may arrange fibers into a more aligned pattern, while a more irregular or spherical shape may arrange the fibers into a more random pattern.

The fiber may be provided from a manufacturer as a chopped fiber, and used directly in the process, or a fiber may be provided in a bulk format, which is typically processed prior to use. Either way, process considerations should take into account how the fiber is to be processed into its final desirable aspect ratio distribution. Generally, the fiber is initially chopped prior to mixing with other additives, and then is further chopped during the mixing, shearing, and extrusion steps. However, extrusion can also be carried out with unchopped fibers by setting the rheology to make the extrusion mix extrudable at reasonable extrusion pressures and without causing dilatency flows in the extrusion mix when placed under pressure at the extrusion die face. It will be appreciated that the chopping of fibers to the proper aspect ratio distribution may be done at various points in the overall process. Once the fiber has been selected and chopped to a usable length, it is mixed with the binder and pore former. This mixing may first be done in a dry form to initiate the mixing process, or may be done as a wet mix process. Fluid, which is typically water, is added to the mixture. In order to obtain the required level of homogeneous distribution, the mixture is shear mixed through one or more stages. The shear mixing or dispersive mixing provides a highly desirable homogeneous mixing process for evenly distributing the fibers in the mixture, as well as further cutting fibers to the desired aspect ratio.

FIG. 6 Table 2 shows several binders available for selection. It will be appreciated that a single binder may be used, or multiple binders may be used. The binders are generally divided into organic and inorganic classifications. The organic binders generally will burn off at a lower temperature during curing, while the inorganic binders will typically form a part of the final structure at a higher temperature. Although several binder selections are listed in Table 2, it will be appreciated that several other binders may be used. FIG. 6 Table 3 shows a list of pore formers available. Pore formers may be generally defined as organic or inorganic, with the organic typically burning off at a lower temperature than the inorganic. Although several pore formers are listed in Table 3, it will be appreciated that other pore formers may be used. FIG. 6 Table 4 shows different fluids that may be used. Although it will be appreciated that water may be the most economical and often used fluid, some applications may require other fluids. Although Table 4 shows several fluids that may be used, it will be appreciated that other fluids may be selected according to specific application and process requirements.

In general, the mixture may be adjusted to have a rheology appropriate for advantageous extrusion. Typically, proper rheology results from the proper selection and mixing of fibers, binders, dispersants, plasticizers, pore formers, and fluids. A high degree of mixing is needed to adequately provide plasticity to the fibers. Once the proper fiber, binder, and pore former have been selected, the amount of fluid is typically finally adjusted to meet the proper rheology. A proper rheology may be indicated, such as by one of two tests. The first test is a subjective, informal test where a bead of mixture is removed and formed between the fingers of a skilled extrusion operator. The operator is able to identify when the mixture properly slides between the fingers, indicating that the mixture is in a proper condition for extrusion. A second more objective test relies on measuring physical characteristics of the mixture. Generally, the shear strength versus compaction pressure can be measured using a confined (i.e. high pressure) annular rheometer. Measurements are taken and plotted according to a comparison of cohesion strength versus pressure dependence. By measuring the mixture at various mixtures and levels of fluid, a rheology chart identifying rheology points may be created. For example, Table 5 FIG. 6 illustrates a rheology chart for a fibrous ceramic mixture. Axis 232 represents cohesion strength and axis 234 represents pressure dependence. The extrudable area 236 represents an area where fibrous extrusion is highly likely to occur. Therefore, a mixture characterized by any measurement falling within area 236 is likely to successfully extrude. Of course, it will be appreciated that the rheology chart is subject to many variations, and so some variation in the positioning of area 236 is to be expected. Additionally, several other direct and indirect tests for measuring rheology and plasticity do exist, and it is appreciated that any number of them can be deployed to check if the mixture has the right rheology for it to be extruded into the final shape of the product desired.

Once the proper rheology has been reached, the mixture is extruded through an extruder. The extruder may be a piston extruder, a single screw extruder, or a twin screw extruder. The extruding process may be highly automated, or may require human intervention. The mixture is extruded through a die having the desired cross sectional shape for the substrate block. The die has been selected to sufficiently form the green substrate. In this way, a stable green substrate is created that may be handled through the curing process, while maintaining its shape and fiber alignment.

The green substrate is then dried and cured. The drying can take place in room conditions, in controlled temperature and humidity conditions (such as in controlled ovens), in microwave ovens, RF ovens, and convection ovens. Curing generally requires the removal of free water to dry the green substrate. It is important to dry the green substrate in a controlled manner so as not to introduce cracks or other structural defects. The temperature may then be raised to burn off additives, such as binders and pore formers. The temperature is controlled to assure the additives are burnt off in a controlled manner. It will be appreciated that additive burn off may require cycling of temperatures through various timed cycles and various levels of heat. Once the additives are burned off, the substrate is heated to the required temperature to form structural bonds at fiber intersection points or nodes. The required temperature is selected according to the type of bond required and the chemistry of the fibers. For example, liquid-assisted sintered bonds are typically formed at a temperature lower than solid state bonds. It will also be appreciated that the amount of time at the bonding temperature may be adjusted according to the specific type of bond being produced. The entire thermal cycle can be performed in the same furnace, in different furnaces, in batch or continuous processes and in air or controlled atmosphere conditions. After the fiber bonds have been formed, the substrate is slowly cooled down to room temperature. It will be appreciated that the curing process may be accomplished in one oven or multiple ovens/furnaces, and may be automated in a production ovens/furnaces, such as tunnel kilns.

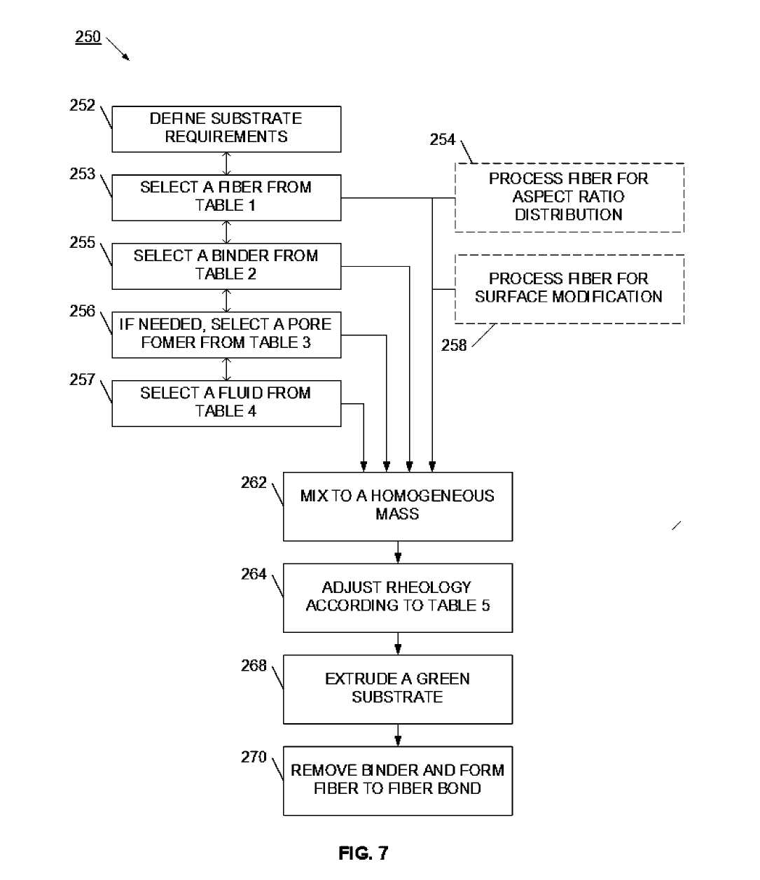

Referring now to FIG. 7, a system for extruding a porous substrate is illustrated. System 250 is a highly flexible process for producing a porous substrate. In order to design the substrate, the substrate requirements are defined as shown in block 252. For example, the final use of the substrate generally defines the substrate requirements, which may include size constraints, temperature constraints, strength constraints, and chemical reaction constraints. Further, the cost and mass manufacturability of the substrate may determine and drive certain selections. For example, a high production rate may entail the generation of relatively high temperatures in the extrusion die, and therefore binders are selected that operate at an elevated temperature without hardening or gelling. In extrusions using high temperature binders, the dies and barrel may need to be maintained at a relatively higher temperature such as 60 to 180 C. In such a case, the binder may melt, reducing or eliminating the need for additional fluid. In another example, a filter may be designed to trap particulate matter, so the fiber is selected to remain unreactive with the particulate matter even at elevated temperatures. It will be appreciated that a wide range of applications may be accommodated, with a wide range of possible mixtures and processes. One skilled in the art will appreciate the trade-offs involved in the selection of fibers, binders, pore formers, fluids, and process steps. Indeed, one of the significant advantages of system 250 is its flexibility as to the selection of mixture composition and the adjustments to the processes.

Once the substrate requirements have been defined, a fiber is selected from Table 1 of FIG. 6 as shown in block 253. The fiber may be of a single type, or may be a combination of two or more types. It will also be appreciated that some fibers may be selected to be consumed during the curing process. Also, additives may be added to the fibers, such as coatings on the fibers, to introduce other materials into the mixture. For example, dispersant agents may be applied to fibers to facilitate separation and arrangement of fibers, or bonding aids may be coated onto the fibers. In the case of bonding aids, when the fibers reach curing temperatures, the bonding aids assist the formation and flowing of liquid state bonds.

A binder is then selected from Table 2 of FIG. 6 as shown in block 255. The binder is selected to facilitate green state strength, as well as controlled burn off. Also, the binder is selected to produce sufficient plasticity in the mixture. If needed, a pore former is selected from Table 3 of FIG. 6 as shown in block 256. In some cases, sufficient porosity may be obtained through the use of fibers and binders only. The porosity is achieved not only by the natural packing characteristics of the fibers, but also by the space occupied by the binders, solvents and other volatile components which are released during the de-binding and curing stages. To achieve higher porosities, additional pore formers may be added. Pore formers are also selected according to their controlled burn off capabilities, and may also assist in plasticizing the mixture. Fluid, which is typically water, is selected from Table 4 FIG. 6 as shown in block 257. Other liquid materials may be added, such as a dispersant, for assisting in separation and arrangement of fibers, and plasticizers and extrusion aids for improving flow behavior of the mixture. This dispersant may be used to adjust the surface electronic charges on the fibers. In this way, fibers may have their charge controlled to cause individual fibers to repel each other. This facilitates a more homogeneous and random distribution of fibers. A typical composition for mixture intended to create a substrate with >80% porosity is shown below. It will be appreciated that the mixture may be adjusted according to target porosity, the specific application, and process considerations.

A typical composition to get >80% porosity:

| | | Density | Mass | Volume | Volume |
|---|---|---|---|---|---|
| | | (g/cc) | (g) | (cc) | (%) |
| Fiber | Mullite | 2.7 | 300.0 | 111.1 | 9.2 |
| Strengthener | Bentonite | 2.6 | 30.0 | 11.5 | 1.0 |
| Binder | HPMC | 0.5 | 140.0 | 280.0 | 23.1 |
| | (Hydroxypropyl | | | | |
| | methylcellulose) | | | | |
| Plasticizer | Propylene | 1.1 | 15.0 | 13.6 | 1.1 |
| | Glycol | | | | |
| Pore former | PMMA | 1.19 | 500.0 | 420.2 | 34.7 |
| | (Polymethyl | | | | |
| | methacrylate) | | | | |
| Fluid | Water | 1 | 375.0 | 375.0 | 31 |

| | | | |
|---|---|---|---|
| Total: | 1360.0 | 1211.5 | 100.0 |

As shown in block 254, the fibers selected in block 252 should be processed to have a proper aspect ratio distribution. This aspect ratio is preferred to be in the range of about 3 to about 500 and may have one or more modes of distribution. It will be appreciated that other ranges may be selected, for example, to about an aspect ratio of 1000. In one example, the distribution of aspect ratios may be randomly distributed throughout the desired range, and in other examples the aspect ratios may be selected at more discrete mode values. It has been found that the aspect ratio is an important factor in defining the packing characteristics for the fibers. Accordingly, the aspect ratio and distribution of aspect ratios is selected to implement a particular strength and porosity requirement. Also, it will be appreciated that the processing of fibers into their preferred aspect ratio distribution may be performed at various points in the process. For example, fibers may be chopped by a third-party processor and delivered at a predetermined aspect ratio distribution. In another example, the fibers may be provided in a bulk form, and processed into an appropriate aspect ratio as a preliminary step in the extrusion process. It will be appreciated that the mixing, shear mixing or dispersive mixing, and extrusion aspects of process 250 may also contribute to cutting and chopping of the fibers. Accordingly, the aspect ratio of the fibers introduced originally into the mixture will be different than the aspect ratio in the final cured substrate. Accordingly, the chopping and cutting effect of the mixing, shear mixing, and extrusion should be taken into consideration when selecting the proper aspect ratio distribution 254 introduced into the process.

With the fibers processed to the appropriate aspect ratio distribution, the fibers, binders, pore formers, and fluids are mixed to a homogeneous mass as shown in block 262. This mixing process may include a drying mix aspect, a wet mix aspect, and a shear mixing aspect. It has been found that shear or dispersive mixing is desirable to produce a highly homogeneous distribution of fibers within the mass. This distribution is particularly important due to the relatively low concentration of ceramic material in the mixture. As the homogeneous mixture is being mixed, the rheology of the mixture may be adjusted as shown in block 264. As the mixture is mixed, its rheology continues to change. The rheology may be subjectively tested, or may be measured to comply with the desirable area as illustrated in Table 5 of FIG. 6. Mixture falling within this desired area has a high likelihood of properly extruding. The mixture is then extruded into a green substrate as shown in block 268. In the case of screw extruders, the mixing may also happen inside the extruder itself, and not in a separate mixer. In such cases, the shear history of the mixture has to be carefully managed and controlled. The green substrate has sufficient green strength to hold its shape and fiber arrangement during the curing process. The green substrate is then cured as shown the block 270. The curing process includes removal of any remaining water, controlled burn off of most additives, and the forming of fiber-to-fiber bonds. During the burn off process, the fibers maintain their tangled and intersecting relationship, and as the curing process proceeds, bonds are formed at the intersecting points or nodes. It will be appreciated that the bonds may result from a liquid state or a solid-state bonding process. Also, it will be understood that some of the bonds may be due to reactions with additives provided in the binder, pore formers, as coatings on the fibers, or in the fibers themselves. After bonds have been formed, the substrate is slowly cooled to room temperature.

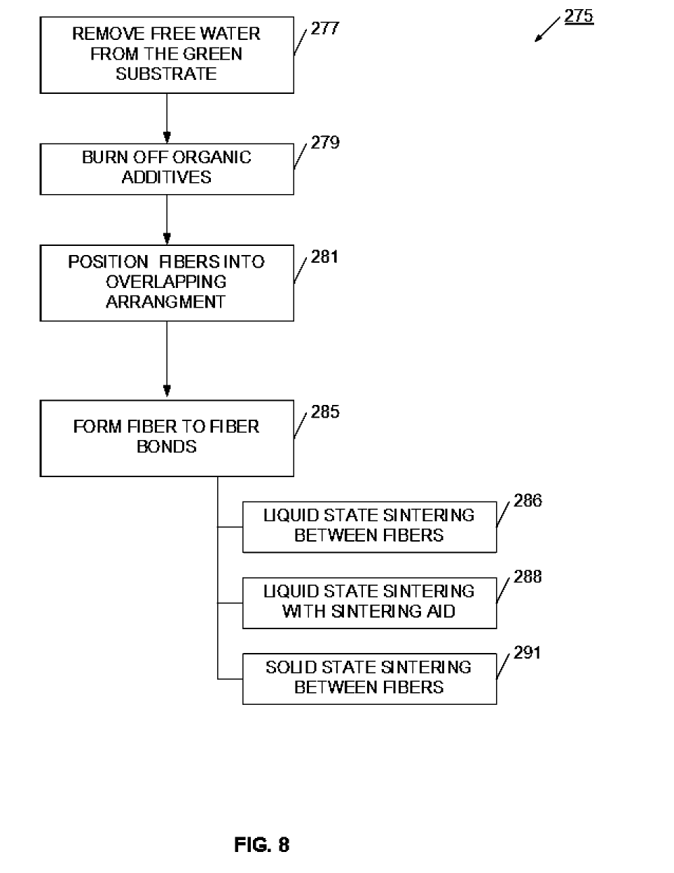

Referring now to FIG. 8, a method for curing a porous fibrous substrate is illustrated. Method 275 has a green substrate having a fibrous ceramic content. The curing process first slowly removes remaining water from the substrate as shown in block 277. Typically, the removal of water may be done at a relatively low temperature in an oven. After the remaining water has been removed, the organic additives may be burnt off as shown in block 279. These additives are burnt off in a controlled manner to facilitate proper arrangement of the fibers, and to ensure that escaping gases and residues do not interfere with the fiber structure. As the additives burn off, the fibers maintain their overlapping arrangement, and may further contact at intersecting points or nodes as shown in block 281. The fibers have been positioned into these overlapping arrangements using the binder, and may have particular patterns formed through the use of pore formers. In some cases, inorganic additives may have been used, which may combine with the fibers, be consumed during the bond forming process, or remain as a part of the final substrate structure. The curing process proceeds to form fiber-to-fiber bonds as shown in block 285. The specific timing and temperature required to create the bonds depends on the type of fibers used, type of bonding aides or agents used, and the type of desired bond. In one example, the bond may be a liquid state sintered bond generated between fibers as shown in block 286. Such bonds are assisted by glass-formers, glasses, ceramic pre-cursors or inorganic fluxes present in the system. In another example, a liquid state sintered bond may be created using sintering aides or agents as shown in block 288. The sintering aides may be provided as a coating on the fibers, as additives, from binders, from pore formers, or from the chemistry of the fibers themselves. Also, the fiber-to-fiber bond may be formed by a solid-state sintering between fibers as shown in block 291. In this case, the intersecting fibers exhibit grain growth and mass transfer, leading to the formation of chemical bonds at the nodes and an overall rigid structure. In the case of liquid state sintering, a mass of bonding material accumulates at intersecting nodes of the fibers, and forms the rigid structure. It will be appreciated that the curing process may be done in one or more ovens, and may be automated in an industrial tunnel or kiln type furnace.

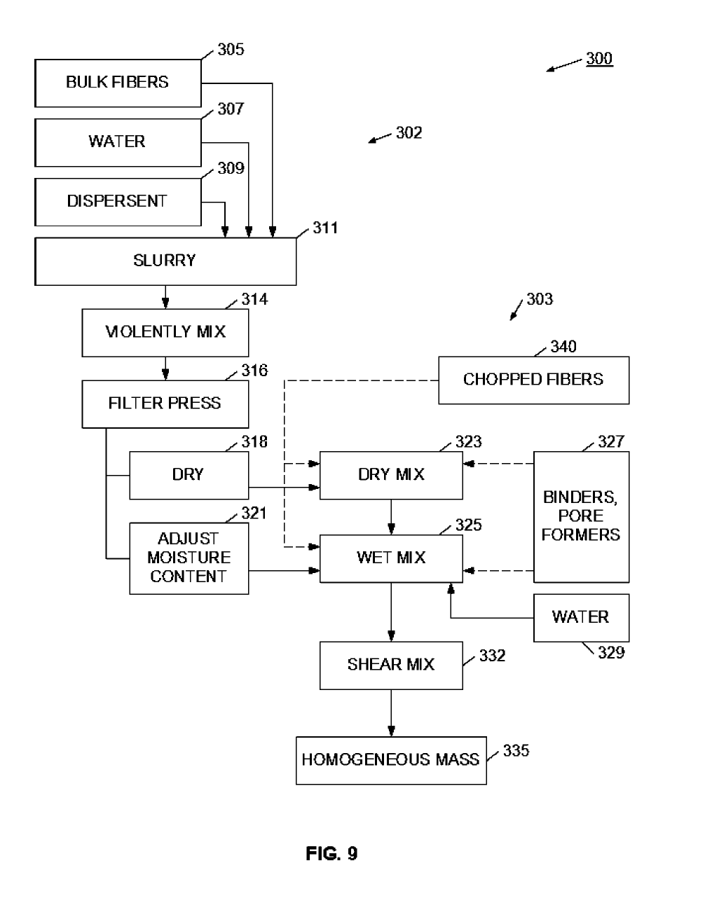

Referring now to FIG. 9, a process for preparing fibers is illustrated. Process 300 shows that bulk fibers are received as shown in block 305. The bulk fibers typically have very long fibers in a clumped and interwoven arrangement. Such bulk fibers must be processed to sufficiently separate and cut the fibers for use in the mixing process. Accordingly, the bulk fibers are mixed with water 307 and possibly a dispersant agent 309 to form a slurry 311. The dispersant 309 may be, for example, a pH adjuster or a charge adjuster to assist the fibers in repelling each other. It will be appreciated that several different types of dispersants may be used. In one example, the bulk fibers are coated with a dispersant prior to introduction into the slurry. In another example, the dispersant is simply added to the slurry mixture 311. The slurry mixture is violently mixed as shown in block 314. This violent mixing acts to chop and separate the bulk fibers into a usable aspect ratio distribution. As described earlier, the aspect ratio for the initial use of the fibers will be different than the distribution in the final substrate, as the mixing and extrusion process further chops the fibers.

After the fibers have been chopped to an appropriate aspect distribution, the water is mostly removed using a filter press 316 or by pressing against a filter in another equipment. It will be appreciated that other water removal processes may be used, such as freeze drying. The filter press may use pressure, vacuum or other means to remove water. In one example the chopped fibers are further dried to a complete dry state as shown in block 318. These dried fibers may then be used in a dry mix process 323 where they are mixed with other binders and dry pore formers as shown in block 327. This initial dry mixing assists in generating a homogeneous mass. In another example, the water content of the filtered fibers is adjusted for proper moisture content as shown in block 321. More particularly, enough water is left in the chopped fiber cake to facilitate wet mixing as shown in block 325. It has been found that by leaving some of the slurry water with the fibers, additional separation and distribution of the fibers may be obtained. Binders and pore formers may also be added at the wet mix stage, and water 329 may be added to obtain the correct rheology. The mass is also shear mixed as shown in block 332. The shear mixing may also be done by passing the mixture through spaghetti shaped dies using a screw extruder, a double screw extruder, or a shear mixer (such as sigma blade-type mixer). The shear mixing or kneading can also take place in a sigma mixer, a high shear mixer, and inside the screw extruder. The shear mixing process is desirable for creating a more homogeneous mass 335 that has desirable plasticity and extrudable rheology for extrusion to work. The homogeneous mass 335 has an even distribution of fibers, with the fibers positioned into an overlapping matrix. In this way, as the homogeneous mass is extruded into a substrate block and cured, the fibers are allowed to bond into a rigid structure. Further, this rigid structure forms an open pore network having high porosity, high permeability, and high surface area.

The fiber extrusion system offers great flexibility in implementation. For example, a wide range of fibers and additives, may be selected to form the mixture. Several mixing and extrusion options exist, as well as options related to curing method, time, and temperature. With the disclosed teachings, one skilled in the extrusion arts will understand that many variations may be used. Honeycomb substrate is a common design to be produced using the technique described in the present invention, but other shapes, sizes, contours, designs can be extruded for various applications.

A fuel cell is an electrochemical energy conversion device similar to a battery, differing in that it is designed for continuous replenishment of the reactants consumed; i.e. it produces electricity from an external supply of fuel and oxygen as opposed to the limited internal energy storage capacity of a battery. Additionally, the electrodes within a battery react and change as a battery is charged, or discharged, whereas a fuel cell's electrodes are catalytic and relatively stable. Fuel cells are used for energy generation in a variety of applications, from electricity generation and portable power units to powering mobile phones and automobiles.

Typical reactants used in a fuel cell are hydrogen on the anode side, and oxygen on the cathode side (a hydrogen cell). Usually, reactants flow in and reaction products flow out. Virtually continuous long-term operation is feasible as long as these flows are maintained.

In many fuel cell systems, there is a fuel reformer that is placed in the stream of the main fuel cell stack. The fuel reformer converts input fuels into hydrogen, often using catalytic processes. In some conditions, this reaction can take place at room temperature while in most places, this reaction takes place under elevated conditions. The reformate stream (i.e. the gases exiting from the reformer and flowing down the path to enter the fuel cell) typically contain many components, including H₂, N₂, CO, CO₂, H₂S, etc. Several of these gases can be cleaned up easily using oxidation type catalysts using, for example, porous substrates adapted as a flow through or wall flow filter. Most importantly, the H₂S gas needs to be discarded or else it will quickly foul and destroy the precious catalysts in the fuel cell reactor. Even miniscule amounts of H₂S (i.e. in low ppm levels) can foul the fuel cell catalysts, resulting in poor performance or non-operation of the fuel cell.

The removal of H₂S is an important step in cleaning up of the reformate stream since most naturally available (or synthesized fuels) contain some sulfur, H₂S is produced in the reformer system. Some interesting methods have been found to remove H₂S from gas streams. Some methods rely on molecular membrane type technologies but those are hard to implement and not very durable. Some recent advances utilize washcoat technology to adsorb H₂S onto surfaces that have particular affinity for H₂S even at ppm levels. In such cases, the washcoat composition is specially designed and configured to attract H₂S and hold onto it while there is H₂S present in the gas stream. Then, at a later time, when the H₂S concentration goes down, or a clean environment is presented, the H₂S is released and captured elsewhere. Such a system can be easily configured for use in a fuel cell environment by using two or more such adsorption cells in parallel in a revolver type system. For example, a flow through honeycomb catalyst providing a high surface area for the washcoat to be placed on can be put in the main reformate stream so that the H₂S in the stream is captured and a gas stream devoid of any H₂S is allowed to pass through to the fuel cell stack. When the washcoat reaches its maximum H₂S holding capacity, the revolver system can be triggered so a new honeycomb substrate is exposed into the main gas stream and the ‘loaded’ substrate is exposed to a clean air or N₂ environment. In such a H₂S-less environment, the H₂S can be released and stored elsewhere or converted into other species. In such a revolving mechanism, no H₂S is allowed to pass through to the main fuel cell stack and the H₂S is essentially captured from the main reformate stream and released outside the system. The bed that adsorbs the gas is fully re-generable and hence lasts a very long time in an application.

Some of the washcoats used include zinc oxide, lanthanum oxide, other rare-earth oxides etc. Often the washcoat loadings can be quite high and washcoats about 20-50 microns thick can be put onto the walls of a honeycomb substrate. Some materials are used to soak completely in sulfur, i.e. to reach a saturation point, while some new studies (e.g. Stephanapoulous et al. Science, Vol. 312, p. 1508 (2006)) have shown using only surface adsorption phenomenon to quickly adsorb and then quickly desorb even trace quantities of sulfur compounds in a gas stream. When applied to the porous substrate of the present invention, the washcoat can penetrate into the porous material, thereby increasing the effective surface area to which the reformate stream can be exposed.

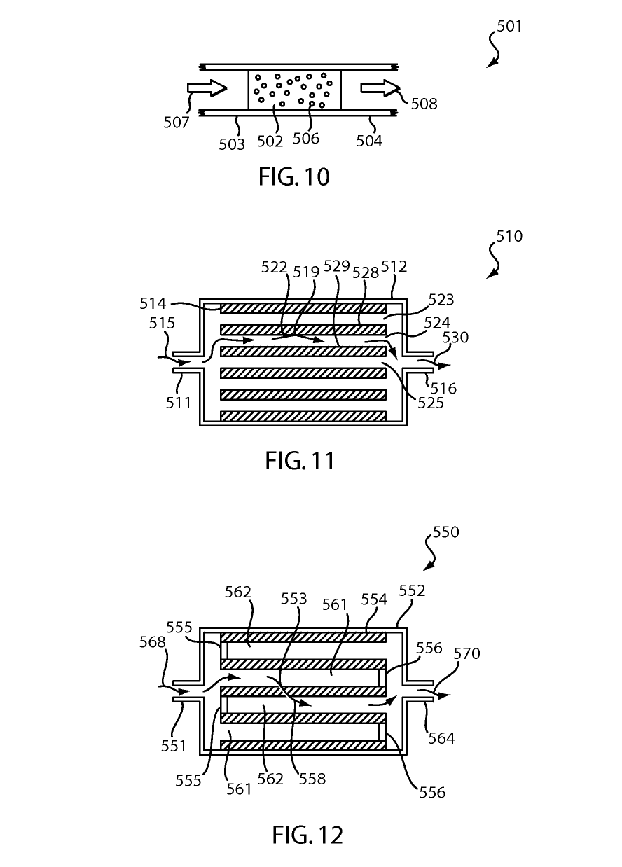

Referring to FIG. 10, a porous substrate 502 is shown as a reformate stream filter 501 in a fuel reformer in a fuel cell system. Input fuel 507 enters the filter 502 through an inlet line 503, and passes through the porous substrate 502. The porous substrate 502 is has a washcoat applied that removes H₂S 506 by adsorption. Clean fuel 508 exits the filter 502 through output line 504 to provide clean fuel to the fuel cell. The porous substrate 502 provides high porosity, high surface area, high permeability, and high temperature capabilities that are particularly well adapted for use in a reformate stream filter. The porous substrate 502 can be fully monolithic, or segmented by assembling any number of smaller sections of formed substrates. In a solid oxide fuel cell application, for example, the operating temperature can be as high as 700-800 degrees Celsius, and a filter substrate must be thermo-mechanically stable at these temperatures while also chemically compatible with the washcoat material. If a reaction take place between the washcoat and the substrate, the washcoat can become fouled and less active in its ability to withhold the reformate gas constituents. The porous substrate described above, particularly those composed mostly of mullite or alumina silica zirconia, or zirconia toughened alumina, are well suited for application as a reformate stream filter. The crystalline, chemically stable mullite structure is substantially non-reactive and allows for good adherence of the washcoat to the substrate. It is highly stable at elevated temperatures and its porosity and pore size distribution can be easily structured.

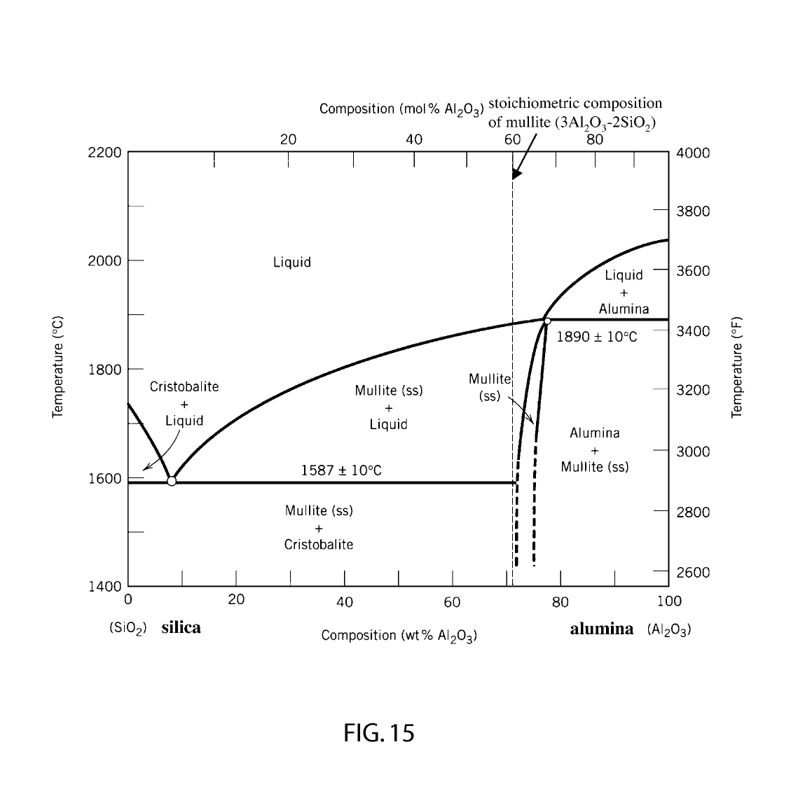

In an exemplary embodiment the porous substrate 502 is composed of mullite fibers having a porosity of about 85%. Mullite is the mineralogical name given to the only chemically stable intermediate phase in the Al₂O₃—SiO₂ system. The natural mineral is rare, naturally occurring on the Isle of Mull off the west coast of Scotland. Mullite is commonly denoted as 3Al₂O₃.2SiO₂ (i.e., 60 mol % Al₂O₃ and 40 mol % SiO₂), though mullite fibers, in this exemplary embodiment, can include a metastable phase of 2Al₂O₃SiO₂ or compositions from 60 mol % to 67 mol % alumina. An alumina-silica phase diagram showing the mullite composition is shown as FIG. 15. In this exemplary embodiment, the mullite fiber composition has particular advantages over conventional ceramic substrate compositions. Mullite powder-based ceramic substrates are highly susceptible to cracking at lower thermal gradients, while the fibrous structural composition provides inherent strain relief when thermally stressed.

FIG. 11 shows a reformate stream filter 510 having a housing portion 512 and a porous substrate 514 in a flow-through configuration. The housing portion 512 includes an inlet line 511 for receiving input fuel 515, and an outlet line 516 for clean fuel 530. The porous substrate 514 has a plurality of channels (typically parallel) formed therethrough, such as channels 523, 524, and 525. The porous substrate 514 is typically formed as a monolith, but may also be formed from section joined together, such as by cement, glue, or other convenient means. The channels 523, 524, and 525 are typically parallel and are formed in situ during the extrusion of the substrate 514. Alternatively, the channels 523, 524, and 525 can be cut, broached or otherwise formed via any convenient processes in the as-formed or green or fired substrate 514 as a substantially fibrous fluid permeable monolithic block.

The porous substrate 514, and particularly the surfaces of the porous substrate forming the walls of the plurality of channels, such as walls 528 and 529 that form channel 524, are coated with a washcoat described above having an affinity for adsorption of H₂S. As the fuel 522 passes through the channels the H₂S from the fuel is trapped on the washcoat material 519 coated on the surface of the substrate.

FIG. 12 shows a reformate stream filter 550 having a housing portion 552 and a porous substrate 554 in a wall-flow configuration. The housing portion 552 includes an inlet line 551 for receiving input fuel 568, and an outlet line 564 for clean fuel 570. The porous substrate 554 has a plurality of channels (typically parallel) formed therethrough, such as channels 561 and 562. Substantially impermeable outlet channel blocks 555 are positioned in outlet channels 562, and substantially impermeable inlet blocks 556 are positioned in inlet channels 561. Typically, the inlet blocks 556 and outlet blocks 555 are made of the same material as the rest of the substrate body 554, or they can be made from any substantially impermeable material compatible with the fuel passed through the system. The blocks 555 and 556 prevent the direct flow of fuel completely through any given channel and thus restrict the flow of fuel into a wall-flow mode of operation. In other words, by forcing input fuel 568 entering through the inlet line 551 to enter the inlet channels 561, the fuel 558 is forced through the porous substrate 554 through the channel walls 563 into the outlet channels 562 to exit the filter as clean fuel 570 through outlet line 564. When the fuel 558 passes through the channel walls 563, it makes contact with the washcoat material 553 coated on the surface of the substrate, thereby trapping H₂S.

Typical sizes of the substrates used in a reformate stream filter in either the flow-through configuration of FIG. 11, or the wall flow configuration of FIG. 12, will vary significantly depending upon the application. For example, on a mobile medium duty truck application, the sizes can vary between two and five inches in diameter and three to ten inches long. A typical size for this application will be a cylindrical substrate three inches in diameter and four inches long.

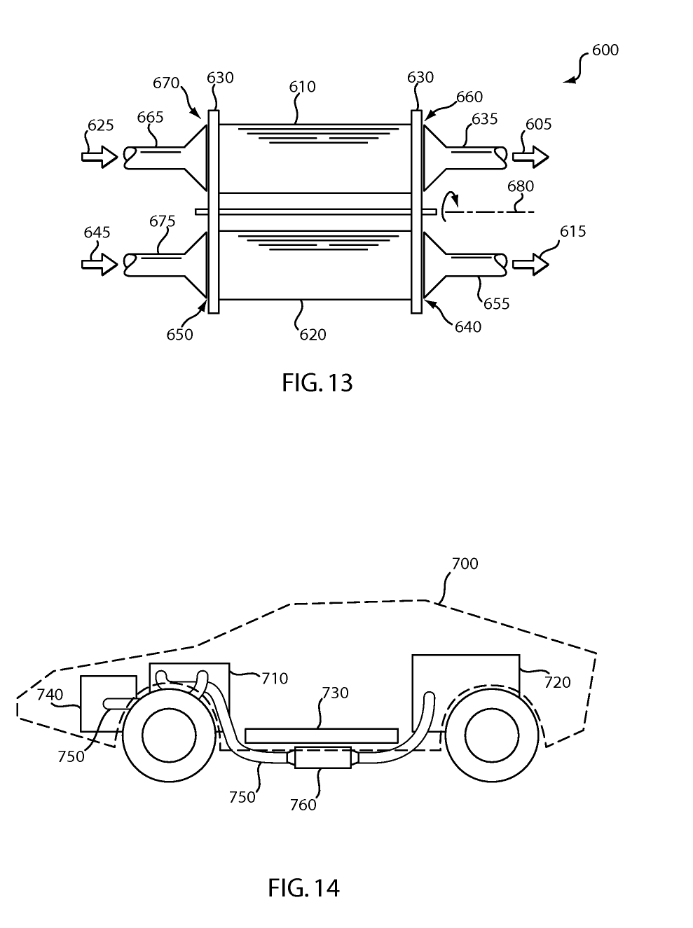

The advantages of a porous substrate to trap H₂S in a reformate stream filter is that when the washcoat becomes saturated with H₂S, the substrate can be taken off-line and regenerated. FIG. 13 shows an exemplary revolver based system 600 that can be used to regenerate a porous substrate saturated with H₂S while another substrate is in use. The revolver based system 600 has a first housing 610 having a porous substrate enclosed therein rigidly mounted to a frame 630. A second housing 620 is rigidly mounted to the frame 630, which has an axis of rotation 680 substantially between the first housing 610 and the second housing 620. In a first position, as shown in FIG. 13, input fuel 625 is provided by an inlet fuel line 663 to direct the input fuel 625 into the first housing 610. Clean fuel 605 exits the first housing through an outlet line 635. In the first position, as shown in FIG. 13, the second housing 620 is in a regeneration position. Regenerating fluid 645 is provided to the regeneration input line 675 to direct the regeneration fluid 645 into the second housing 620. The regeneration fluid containing waste H₂S 615 exits the second housing 620 through a waste line 655. The regeneration fluid 645 can be a variety of clean fluids, including nitrogen, or filtered compressed air, since the H₂S trapped on the surface of the washcoat on the porous substrate is released by continued exposure to a fluid having a low concentration of H₂S. The regeneration fluid 645 can be provided to the second housing in a flow direction similar to the flow direction of the input fuel 625, or the regeneration fluid 645 can be provided to the second housing in a reverse flow direction from the direction of the input fuel 625.

In an exemplary embodiment, the H₂S-less exhaust gas leaving the first adsorbing substrate in a revolver-type system is moved into the fuel cell assembly for energy conversion, and then the exhaust gas from the fuel cell is passed through the second desorbing substrate in the revolver system to release the H₂S into the exhaust stream. This way no extra air-flow system is required for desorbing the H₂S from the saturated substrates.

In the exemplary embodiment shown in FIG. 13, the revolver based system 600 can rotate about the axis of rotation 680 to swap the position of the first housing 610 and the second housing 620 after the first housing 610 become saturated with H₂S, and after the second housing 620 is regenerated. A removable fitting, or sliding O-ring seal can be provided at the first housing input 670, first housing output 660, second housing input 650, and second housing output 640. One skilled in the art will appreciate that various alternative means for rotation of a plurality of housings can be provided, including, for example, the use of various valve fittings to effectively swap the flow of fuel and regenerating fluid.

FIG. 14 shows the porous substrate in a fuel reformer cleanup filter 760 in a mobile vehicle 700. A fuel cell system 720 generates electricity that is stored in battery storage 730 using hydrogen generated from reforming fuel 740 by the fuel processing system 710. The reformed hydrogen from the fuel processing system 710 is routed through the fuel reformer cleanup filter 760 where it is cleaned, as described above, and then routed to the fuel cell system 720. The vehicle 700 has an electric motor (not shown) that is powered by electricity stored in the battery storage 730, as produced upon demand by the fuel cell system 720.

While particular preferred and alternative embodiments of the present intention have been disclosed, it will be apparent to one of ordinary skill in the art that many various modifications and extensions of the above described technology may be implemented using the teaching of this invention described herein. All such modifications and extensions are intended to be included within the true spirit and scope of the invention as discussed in the appended claims.

What is claim is:

1. A fuel cell reformate cleanup substrate comprising:
a porous honeycomb ceramic substrate placed in a stream of reformed hydrogen fuel from a fuel cell reformer, the porous ceramic substrate having;
a porosity in the range of about 60% to about 85%;
a structure formed of bonded ceramic fibers;
the substrate produced by an extrusion process comprising;
mixing ceramic-material fiber with additives and a fluid to form an extrudable mixture;
extruding the extrudable mixture into a green substrate;
curing the green substrate into the porous ceramic substrate; and
a washcoat applied to at least a portion of the porous ceramic substrate, the washcoat adapted to adsorb components from the reformed hydrogen fuel stream.

2. The fluid filter according to claim 1 wherein the structure formed of bonded ceramic fibers further comprises mullite fibers.

3. The fluid filter according to claim 1 wherein the porous ceramic substrate is a flow-through configuration.

4. The fluid filter according to claim 3 wherein the structure formed of bonded ceramic fibers further comprises mullite fibers.

5. The fluid filter according to claim 1 wherein the porous ceramic substrate is a wall-flow configuration.

6. The fluid filter according to claim 5 wherein the structure formed of bonded ceramic fibers further comprises mullite fibers.

7. A method of altering a composition of a gas comprising:
providing a porous ceramic substrate;
the substrate having a porosity in the range of about 60% to about 85%;
the substrate having a structure formed of bonded ceramic fibers;
the substrate produced by an extrusion process comprising;
mixing ceramic-material fiber with additives and a fluid to form an extrudable mixture;
extruding the extrudable mixture into a green substrate;
curing the green substrate into the porous ceramic substrate;
the substrate having a washcoat applied to at least a portion of the porous ceramic substrate, the washcoat adapted to reversibly adsorb components in the gas; and
exposing the porous ceramic substrate to a gas stream.

8. The method according to claim 7 wherein the ceramic-material fiber comprises mullite.

9. The method according to claim 7 wherein the step of exposing the porous ceramic substrate to a gas stream is performed on a mobile vehicle.

10. The method according to claim 7 wherein the step of exposing the porous ceramic substrate to a gas stream is performed on a stationary system.

11. A fuel cell reformate cleanup filter comprising:
an extruded fiber-based honeycomb ceramic substrate, the substrate comprising bonded ceramic fibers, the ceramic fibers providing porosity within the substrate; and
a washcoat disposed within the ceramic substrate having an affinity for the adsorption of hydrogen sulfide;
wherein hydrogen sulfide in a reformate stream is adsorbed by the washcoat as the stream is passed through the ceramic substrate.

12. The fuel cell reformate cleanup filter according to claim 11 wherein the washcoat further comprises zinc oxide.

13. The fuel cell reformate cleanup filter according to claim 11 wherein the washcoat further comprises lanthanum oxide.

14. The fuel cell reformate cleanup filter according to claim 11 wherein the washcoat is a rare-earth oxide.

15. The fuel cell reformate cleanup filter according to claim 11 wherein the washcoat penetrates into the porous ceramic substrate.

16. The fuel cell reformate cleanup filter according to claim 11 wherein the extruded fiber-based honeycomb ceramic substrate has a wall-flow configuration.

17. The fuel cell reformate cleanup filter according to claim 11 wherein the porosity is provided within the substrate by space between the bonded ceramic fibers.

18. The fuel cell reformate cleanup filter according to claim 11 further comprising a revolver assembly to desorb the washcoat disposed within the ceramic substrate when the washcoat is saturated with hydrogen sulfide.

19. The fuel cell reformate cleanup filter according to claim 18 further comprising an exhaust gas from a fuel cell directed to the revolver assembly to desorb the washcoat.

20. The fuel cell reformate cleanup filter according to claim 19 wherein the exhaust gas from the fuel cell is directed to the revolver assembly in a flow direction different from a flow direction of the fuel cell reformate stream as it is passed through the ceramic substrate.
